(19) United States
(12) Patent Application Publication
(10) Pub. No.: US 2019/0390112 A1
(43) Pub. Date: Dec. 26, 2019

(54) LIQUID-CRYSTALLINE MEDIUM

(71) Applicant: Merck Patent GmbH, Darmstadt (DE)

(72) Inventors: Harald HIRSCHMANN, Darmstadt (DE); Sabine SCHOEN, Herten (DE)

(73) Assignee: Merck Patent GmbH, Darmstadt (DE)

(21) Appl. No.: 16/447,065

(22) Filed: Jun. 20, 2019

(30) Foreign Application Priority Data
Jun. 21, 2018 (DE) 102018005326.2

(51) Int. Cl. C09K 19/12; C09K 19/16; C09K 19/30

(52) U.S. Cl. CPC C09K 19/12; C09K 19/16; C09K 19/3098; G02F 1/1362; C09K 2019/123; C09K 2019/163; C09K 2019/3016

(57) ABSTRACT

A liquid-crystalline medium and the use thereof for an active-matrix display, in particular based on the VA, PSA, PS-VA, PM-VA, SS-VA, PALC, IPS, PS-IPS, FFS or PS-FFS effect.

The present invention relates to a liquid-crystalline medium (LC medium), to he use thereof for electro-optical purposes, in particular for electro-optical displays having active-matrix addressing based on the ECB effect and for IPS (in-plane switching) displays or FFS (fringe field switching) displays, and to displays containing this medium.

The principle of electrically controlled birefringence, the ECB effect or also DAP (deformation of aligned phases) effect, was described for the first time in 1971 (M. F. Schieckel and K. Fahrenschon, “Deformation of nematic liquid crystals with vertical orientation in electrical fields”, Appl. Phys. Lett. 19 (1971), 3912). This was followed by papers by J. F. Kahn (Appl. Phys. Lett. 20 (1972), 1193) and G. Labrunie and J. Robert (J. Appl. Phys. 44 (1973), 4869).

The papers by J. Robert and F. Clerc (SID 80 Digest Techn. Papers (1980), 30), J. Duchene (Displays 7 (1986), 3) and H. Schad (SID 82 Digest Techn. Papers (1982), 244) showed that liquid-crystalline phases must have high values for the ratio of the elastic constants K₃/K₁, high values for the optical anisotropy Δn and values for the dielectric anisotropy of Δε≤−0.5 in order to be suitable for use in high-information display elements based on the ECB effect. Electro-optical display elements based on the ECB effect have a homeotropic edge alignment (VA technology=vertically aligned). Dielectrically negative liquid-crystal media can also be used in displays which use the so-called IPS or FFS effect.

Displays which use the ECB effect, as so-called VAN (vertically aligned nematic) displays, for example in the MVA (multi-domain vertical alignment, for example: Yoshide, H. et al., paper 3.1: “MVA LCD for Notebook or Mobile PCs . . . ”, SID 2004 International Symposium, Digest of Technical Papers, XXXV, Book I, pp. 6 to 9, and Liu, C. T. et al., paper 15.1: “A 46-inch TFT-LCD HDTV Technology . . . ”, SID 2004 International Symposium, Digest of Technical Papers, XXXV, Book II, pp. 750 to 753), PVA (patterned vertical alignment, for example: Kim, Sang Soo, paper 15.4: “Super PVA Sets New State-of-the-Art for LCD-TV”, SID 2004 International Symposium, Digest of Technical Papers, XXXV, Book II, pp. 760 to 763), ASV (advanced super view, for example: Shigeta, Mitzuhiro and Fukuoka, Hirofumi, paper 15.2: “Development of High Quality LCDTV”, SID 2004 International Symposium, Digest of Technical Papers, XXXV, Book II, pp. 754 to 757) modes, have established themselves as one of the three more recent types of liquid-crystal display that are currently the most important, in particular for television applications, besides IPS (in-plane switching) displays (for example: Yeo, S. D., paper 15.3: “An LC Display for the TV Application”, SID 2004 International Symposium, Digest of Technical Papers, XXXV, Book II, pp. 758 & 759) and the long-known TN (twisted nematic) displays. The technologies are compared in general form, for example, in Souk, Jun, SID Seminar 2004, seminar M-6: “Recent Advances in LCD Technology”, Seminar Lecture Notes, M-6/1 to M-6/26, and Miller, Ian, SID Seminar 2004, seminar M-7: “LCD-Television”, Seminar Lecture Notes, M-7/1 to M-7/32. Although the response times of modern ECB displays have already been significantly improved by addressing methods with overdrive, for example: Kim, Hyeon Kyeong et al., paper 9.1: “A 57-in. Wide UXGA TFT-LCD for HDTV Application”, SID 2004 International Symposium, Digest of Technical Papers, XXXV, Book I, pp. 106 to 109, the achievement of video-compatible response times, in particular on switching of grey shades, is still a problem which has not yet been satisfactorily solved.

Industrial application of this effect in electro-optical display elements requires LC media which have to satisfy a multiplicity of requirements. Particularly important here are chemical resistance to moisture, air and physical influences, such as heat, infrared, visible and ultraviolet radiation and direct and alternating electric fields.

Furthermore, industrially usable LC media are required to have a liquid-crystalline mesophase in a suitable temperature range and low viscosity. None of the hitherto-disclosed series of compounds having a liquid-crystalline mesophase includes a single compound which meets all these requirements. Mixtures of two to 25, preferably three to 18, compounds are therefore generally prepared in order to obtain materials which can be used as LC media. However, it has not been possible to prepare optimum phases easily in this way since no liquid-crystal materials having significantly negative dielectric anisotropy and adequate long-term stability were hitherto available.

Matrix liquid-crystal displays (MLC displays) are known. Non-linear elements which can be used for individual switching of the individual pixels are, for example, active elements (i.e. transistors). The term “active matrix” is then used, where a distinction can be made between two types:
1. MOS (metal oxide semiconductor) transistors on a silicon wafer as substrate
2. thin-film transistors (TFTs) on a glass plate as substrate.

In the case of type 1, the electro-optical effect used is usually dynamic scattering or the guest-host effect. The use of single-crystal silicon as substrate material restricts the display size, since even modular assembly of various part-displays results in problems at the joints.

In the case of the more promising type 2, which is preferred, the electro-optical effect used is usually the TN effect.

A distinction is made between two technologies: TFTs comprising compound semiconductors, such as, for example, CdSe, or TFTs based on polycrystalline or amorphous silicon. The latter technology is being worked on intensively worldwide.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is located opposite each switchable pixel.

The term MLC displays here covers any matrix display with integrated non-linear elements, i.e. besides the active matrix, also displays with passive elements, such as varistors or diodes (MIM=metal-insulator-metal).

MLC displays of this type are particularly suitable for TV applications (for example pocket TVs) or for high-information displays in automobile or aircraft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff., Paris; STROMER, M., Proc. Eurodisplay 84, September 1984: Design of Thin Film Transistors for Matrix Addressing of Television Liquid Crystal Displays, pp. 145 ff., Paris]. With decreasing resistance, the contrast of an MLC display deteriorates. Since the specific resistance of the liquid-crystal mixture generally drops over the life of an MLC display owing to interaction with the inside surfaces of the display, a high (initial) resistance is very important for displays that have to have acceptable resistance values over a long operating period.

There is thus still a great demand for MLC displays having fast response times at the same time as a large working-temperature range and a low threshold voltage, with the aid of which various grey shades can be generated.

The disadvantage of the MLC-TN displays frequently used is due to their comparatively low contrast, the relatively high viewing-angle dependence and the difficulty of generating grey shades in these displays.

VA displays have significantly better viewing-angle dependences and are therefore principally used for televisions and monitors. However, there continues to be a need to improve the response times here, in particular in view of use for televisions having frame rates (image change frequency/refresh rate) of greater than 60 Hz. However, the properties, such as, for example, the low-temperature stability, must not be impaired at the same time.

The invention is based on the object of providing liquid-crystal mixtures, in particular for monitor and TV applications, based on the ECB effect or on the IPS or FFS effect, which do not have the disadvantages indicated above, or only do so to a reduced extent. In particular, it must be ensured for monitors and televisions that they also work at extremely high and extremely low temperatures and at the same time have very short response times and at the same time have improved reliability behaviour, in particular exhibit no or significantly reduced image sticking after long operating times.

Surprisingly, it is possible to reduce the ratio of rotational viscosity 71 and the elastic constant K₃₃ (γ₁/K₃₃) and thus to improve the response times, and at the same time to achieve high reliability and low-temperature stability (LTS), if a compound of the formulae IA and IB below and one or more compounds of the formula EY below are in each case used in liquid-crystal mixtures, in particular in LC mixtures having negative dielectric anisotropy, preferably for VA, IPS and FFS displays, furthermore for PM (passive matrix)-VA displays.

Surprisingly, the combination of the compounds of the formulae IA and IB with the compounds of the formula EY results in liquid-crystalline media which simultaneously have a very low rotational viscosity and a high absolute value of the dielectric anisotropy as well as high reliability and high LTS. It is therefore possible to prepare liquid-crystal mixtures, preferably VA, IPS and FFS mixtures, which have very short response times, at the same time good phase properties and good low-temperature behaviour.

The invention thus relates to a liquid-crystalline medium, preferably having negative dielectric anisotropy (Δε), which comprises one or more compounds of the formula EY

and

one or more compounds selected from the group of the compounds of the formulae IA and IB

and/or one or more compounds selected from the group of the compounds of the formulae BF-1, BF-2, BS-1 and BS-2:

in which the individual radicals in each case, independently of one another, and identically or differently on each occurrence, have one of the following meanings:
R¹, R^{1*},
R^{1A}, R^{1B} and R^{B} denote H, an alkyl or alkenyl radical having up to 15 C atoms which is unsubstituted, monosubstituted by CN or CF₃ or at least monosubstituted by halogen, where, in addition, one or more CH₂ groups in these radicals may be replaced by —O—, —S—,

—C≡C—, —CF₂O—, —F₂O—, —OCF₂—, —OC—O— or —O—CO— in such a way that O atoms are not linked directly to one another,

on each occurrence, identically or differently, denotes,

preferably

L¹, L², independently of one another, denote F or Cl, preferably F,
L³, L⁴ in each case, independently of one another, denote F, Cl, CF₃ or CHF₂, preferably F,
L⁵ denotes H or methyl,
alkyl denotes a straight-chain alkyl adical having 1 to 6 C atoms, preferably methyl, ethyl, n-propyl or n-butyl,
(O) denotes O or a single bond,
Z^{2A} and Z^{2B} in each case, independently of one another, denote —CH₂CH₂—, —CH═CH—, —CF₂O—, —OCF₂—, —CH₂O—, —OCH₂—, —COO—, —OCO—, —C₂F₄—, —CF═CF— or —CH═CHCH₂O—,
p denotes 1 or 2,
q denotes 0 or 1,
c denotes 0, 1 or 2, and
d denotes 1 or 2.

The invention furthermore relates to an electro-optical display having active-matrix addressing, in particular based on the ECB, VA, PS-VA, PVA, PM-VA, SS-VA, PALC, IPS, PS-IPS, FFS or PS-FFS effect, in particular on the UB-FFS or PS-FFS effect, characterised in that it comprises, as dielectric, a liquid-crystalline medium as described above and below.

The liquid-crystalline media according to the invention preferably exhibit very broad nematic phase ranges with clearing points ≥70° C., preferably ≥74° C., very favourable values of the capacitive threshold, relatively high values of the holding ratio and at the same time very good low-temperature stabilities at −20° C. and −30° C., as well as low rotational viscosities and short response times. The liquid-crystalline media according to the invention are furthermore distinguished by the fact that, in addition to the improvement in the rotational viscosity γ₁, relatively high values of the elastic constants K₃₃ for improving the response times can be observed, i.e. a particularly low ratio γ₁/K₃₃.

In the formulae above and below, an alkyl radical or alkoxy radical may be straight-chain or branched. It is preferably straight-chain, has 2, 3, 4, 5, 6 or 7 C atoms and accordingly preferably denotes ethyl, propyl, butyl, pentyl, hexyl, heptyl, ethoxy, propoxy, butoxy, pentoxy, hexoxy or heptoxy, furthermore methyl, octyl, nonyl, decyl, undecyl, dodecyl, tridecyl, tetradecyl, pentadecyl, methoxy, octoxy, nonoxy, decoxy, undecoxy, dodecoxy, tridecoxy or tetradedoxy.

Oxaalkyl preferably denotes straight-chain 2-oxapropyl (=methoxymethyl), 2-(=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6-, or 7-oxaoctyl, 2-, 3-, 4-, 5-, 6-, 7- or 8-oxanonyl or 2-, 3-, 4-, 5-, 6-, 7-, 8- or 9-oxadecyl.

An alkenyl radical may be straight-chain or branched. It is preferably straight-chain and has 2 to 10 C atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept-1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl or dec-1-, -2-, -3-, -4-, -5-, -6-, -7-, -8- or -9-enyl.

If an alkyl or alkenyl radical is at least monosubstituted by halogen, this radical is preferably straight-chain and halogen is preferably F or Cl. In the case of polysubstitution, halogen is preferably F. The resultant radicals also include perfluorinated radicals. In the case of monosubstitution, the fluorine or chlorine substituent can be in any desired position, but is preferably in the ω position.

Particular preference is given to compounds in which “alkenyl” denotes vinyl, prop-1-enyl, prop-2-enyl or but-3-enyl.

Some preferred embodiments of the mixtures according to the invention are given below.

In the compounds of the formula EY, R¹ and R^{1*} preferably denote alkoxy having ≥2, particularly preferably 2 to 6, C atoms and L¹=L²=F.

Particular preference is given to compounds of the formula EY selected from the group consisting of the following sub-formulae:

Particular preference is given to compounds of the formulae EY-15 to EY-27. Very particular preference is given to the compound of the formula EY-15.

In a preferred embodiment of the present invention, the medium comprises one or more compounds selected from the group of the compounds of the formulae IA and IB in which Z^{2A} and Z^{2B}, independently of one another, denote —CH₂CH₂—, —CH₂O— or —OCH₂—, very particularly preferably —CH₂O— or —OCH₂—.

Particularly preferred compounds of the formulae IA and IB are the compounds of the sub-formulae IA-1 to IA-192:

in which

alkyl and alkyl* in each case, independently of one another, denote a straight-chain alkyl radical having 1-6 C atoms, alkoxy denotes a straight-chain alkoxy radical having 1-6 C atoms, and alkenyl denotes a straight-chain alkenyl radical having 2-6 C atoms.

Of the said sub-formulae IA-1 to IA-192 particular preference is given to the compounds of the formulae IA-1, IA-13, IA-73 and IA-85, in particular the compounds of the formulae IA-1 and IA-73.

In a very particularly preferred embodiment, the mixtures according to the invention comprise one or more compounds of the formula IA-1 and one or more compounds of the formula IA-73.

The mixtures according to the invention very particularly preferably comprise at least one compound from the following group:

Of the preferred compounds of the formulae IA-1a to IA-1p and IA-73a to IA-73y, the compounds IA-1f and IA-73f are very particularly preferred.

The mixtures according to the invention particularly preferably comprise the compound IA-1f or IA-73f.

The mixtures according to the invention very particularly preferably comprise the compounds IA-1f and IA-73f.

Preferred compounds of the formulae BF and BS are selected from the compounds of the following sub-formulae:

in which
alkyl and alkyl* in each case, independently of one another, denote a straight-chain alkyl radical having 1-6 C atoms, and
alkenyl and
alkenyl* in each case, independently of one another, denote a straight-chain alkenyl radical having 2-6 C atoms, and
alkenyloxy denotes a straight-chain alkenyloxy radical having 2-6 C atoms.

Further preferred embodiments of the liquid-crystalline medium according to the invention are indicated below:
a) Liquid-crystalline medium which additionally comprises one or more compounds selected from the group of the compounds of the formulae IIA, IIB and IIC,

in which
R^{2A}, R^{2B} and R^{2C} in each case, independently of one another, denote H, an alkyl or alkenyl radical having up to 15 C atoms which is unsubstituted, monosubstituted by CN or CF₃ or at least monosubstituted by halogen, where, in addition, one or more CH₂ groups in these radicals may be replaced by —O—, —S—,

—C≡C—, —CF₂O—, —OCF₂—, —OC—O— or —O—CO— in such a way that O atoms are not linked directly to one another,
L¹⁻⁴ in each case, independently of one another, denote F, Cl, CF₃ or CHF₂,
L⁵ denotes H or methyl,
p denotes 1 or 2,
q denotes 0 or 1,
v denotes an integer from 1 to 6, and
(O) denotes an oxygen atom or a single bond.
In the compounds of the formulae IIA, IIB and IIC, R^{2A}, R^{2B} and R^{2C} in each case preferably denote alkyl having 1-6 C atoms, in particular CH₃, C₂H₅, n-C₃H₇, n-C₄H₉, n-C₅H₁₁, or cyclopropyl, cyclobutyl, cyclopentyl or cyclopropylmethyl.
In the compounds of the formulae IIA and IIB, L¹, L², L³ and L⁴ preferably denote L¹=L²=F and L³=L⁴=F, furthermore L¹=F and L²=Cl, L¹=Cl and L²=F, L³=F and L⁴=Cl, L³=Cl and L⁴=F. Z² and Z^{2′} in the formulae IIA and IIB preferably in each case, independently of one another, denote a single bond, furthermore a —C₂H₄— or —CH₂O— bridge.
If in the formula IIB Z²═—C₂H₄— or —CH₂O—, Z^{2′} is preferably a single bond or, if Z^{2′}═—C₂H₄— or —CH₂O—, Z² is preferably a single bond. In the compounds of the formulae IIA and IIB, (O)CᵥH₂ᵥ₊₁ preferably denotes OCᵥH₂ᵥ₊₁, furthermore CᵥH₂ᵥ₊₁. In the compounds of the formula IIC, (O)CᵥH₂ᵥ₊₁ preferably denotes CᵥH₂ᵥ₊₁. In the compounds of the formula IIC, L³ and L⁴ preferably in each case denote F.
Preferred compounds of the formulae IIA, IIB and IIC are indicated below:

in which alkyl and alkyl* in each case, independently of one another, denote a straight-chain alkyl radical having 1-6 C atoms and alkenyl denotes a straight-chain alkenyl radical having 2-6 C atoms, and p is 1 or 2.
Particularly preferred mixtures according to the invention comprise one or more compounds selected from the formulae IIA-2, IIA-8, IIIB-2, IIB-11 and IIC-1.
The proportion of compounds of the formulae IIA and/or IIB in the mixture as a whole is preferably at least 20% by weight.
Particularly preferred media according to the invention comprise at least one compound of the formula IIC-1,

in which alkyl and alkyl* have the meanings indicated above, preferably in amounts of >3% by weight, in particular >5% by weight and particularly preferably 5-25% by weight.
b) Liquid-crystalline medium which additionally comprises one or more compounds of the formula III,

in which
R³¹ and R³² in each case, independently of one another, denote a straight-chain alkyl, alkoxyalkyl or alkoxy radical having up to 12 C atoms,

denotes

and
Z³ denotes a single bond, —CH₂CH₂—, —CH═CH—, —CF₂O—, —OCF₂—, —CH₂O—, —OCH₂—, —COO—, —OCO—, —C₂F₄—, —C₄H₈—, —CF═CF—.
Preferred compounds of the formula III are indicated below:

in which
alkyl and
alkyl* in each case, independently of one another, denote a straight-chain alkyl radical having 1-6 C atoms.
The medium according to the invention preferably comprises at least one compound of the formula IIIa and/or formula IIIb.
The proportion of compounds of the formula III in the mixture as a whole is preferably at least 5% by weight.
c) Liquid-crystalline medium which additionally comprises one or more tetracyclic compounds of the formulae

in which
R⁷⁻¹⁰ in each case, independently of one another, have one of the meanings indicated for R^{2A} in formula IIA, and
w and x in each case, independently of one another, denote an integer from 1 to 6.
Particular preference is given to mixtures comprising at least one compound of the formula V-9.
d) Liquid-crystalline medium which additionally comprises one or more compounds of the formulae Y-1 to Y-6,

in which R¹⁴-R¹⁹ in each case, independently of one another, denote an alkyl or alkoxy radical having 1-6 C atoms, and z and m in each case, independently of one another, denote an integer from 1 to 6.
The medium according to the invention particularly preferably comprises one or more compounds of the formulae Y-1 to Y-6, preferably in amounts of ≥5% by weight.
e) Liquid-crystalline medium additionally comprising one or more fluorinated terphenyls of the formulae T-1 to T-21,

in which
R denotes a straight-chain alkyl or alkoxy radical having 1-7 C atoms or alkenyl having 2-7 C atoms, (0) denotes an oxygen atom or a single bond, and m=0, 1, 2, 3, 4, 5 or 6 and n denotes 0, 1, 2, 3 or 4.
R preferably denotes methyl, ethyl, propyl, butyl, pentyl, hexyl, methoxy, ethoxy, propoxy, butoxy, pentoxy.
The medium according to the invention preferably comprises the terphenyls of the formulae T-1 to T-21 in amounts of 2-30% by weight, in particular 5-20% by weight.
Particular preference is given to compounds of the formulae T-1, T-2, T-20 and T-21. In these compounds, R preferably denotes alkyl, furthermore alkoxy, in each case having 1-5 C atoms. In the compounds of the formula T-20, R preferably denotes alkyl or alkenyl, in particular alkyl. In the compound of the formula T-21, R preferably denotes alkyl.
The terphenyls are preferably employed in the mixtures according to the invention if the Δn value of the mixture is to be ≥0.1. Preferred mixtures comprise 2-20% by weight of one or more terphenyl compounds selected from the group of the compounds T-1 to T-21. Particular preference is given to compounds of the formula T-4.
f) Liquid-crystalline medium additionally comprising one or more biphenyls of the formulae B-1 to B-4,

in which
alkyl and alkyl* in each case, independently of one another, denote a straight-chain alkyl radical having 1-6 C atoms,
alkenyl and alkenyl* in each case, independently of one another, denote a straight-chain alkenyl radical having 2-6 C atoms, and
alkoxy denotes a straight-chain alkoxy radical having 1-6 C atoms.
The proportion of the biphenyls of the formulae B-1 to B-4 in the mixture as a whole is preferably at least 3% by weight, in particular ≥5% by weight.
The proportion of the biphenyls of the formulae B-1 to B-4 in the mixture as a whole is preferably in the range 3-15% by weight.
Of the compounds of the formulae B-1 to B-4, the compounds of the formula B-2 are particularly preferred.
Particularly preferred biphenyls are

in which alkyl* denotes an alkyl radical having 1-6 C atoms. The medium according to the invention particularly preferably comprises one or more compounds of the formulae B-1a and/or B-2c.
g) Liquid-crystalline medium comprising at least one compound of the formulae Z-1 or Z-2,

in which
R denotes a straight-chain alkyl or alkoxy radical having 1-7 C atoms or an alkenyl radical having 2-7 C atoms,
alkyl denotes an alkyl radical having 1-6 C atoms, and (O)alkyl denotes alkyl or Oalkyl.
h) Liquid-crystalline medium comprising at least one compound of the formulae O-1 to O-17,

in which R¹ and R² have the meanings indicated for R^{2A} in formula IIA. R¹ and R² preferably in each case, independently of one another, denote straight-chain alkyl having 1-6 C atoms or R¹ denotes straight-chain alkyl having 1-6 C atoms and R² denotes alkenyl having 2-6 C atoms.
Preferred media comprise one or more compounds of the formulae O-1, O-3, O-4, O-5, O-9, O-12, O-14, O-15, O-16 and/or O-17.
Mixtures according to the invention very particularly preferably comprise the compounds of the formulae O-9, O-12, O-16 and/or O-17, in particular in amounts of 5-30%.
Preferred compounds of the formulae O-9 and O-17 are indicated below:

The medium according to the invention particularly preferably comprises the tricyclic compounds of the formula O-9a and/or of the formula O-9b in combination with one or more bicyclic compounds of the formulae O-17a and O-17b. The total proportion of the compounds of the formulae O-9a and/or O-9b in combination with one or more compounds selected from the bicyclic compounds of the formulae O-17a and O-17b is preferably 5-40%, very particularly preferably 15-35%.
Very particularly preferred mixtures comprise the compounds O-9a and O-17a:

The compounds O-9a and O-17a are preferably present in the mixture in a concentration of 15-35%, particularly preferably 15-25% and especially preferably 18-22%, based on the mixture as a whole.
Very particularly preferred mixtures comprise the compounds O-9b and O-17a:

The compounds O-9b and O-17a are preferably present in the mixture in a concentration of 15-35%, particularly preferably 15-25% and especially preferably 18-22%, based on the mixture as a whole.
Very particularly preferred mixtures comprise the following three compounds:

The compounds O-9a, O-9b and O-17a are preferably present in the mixture in a concentration of 15-35%, particularly preferably 15-25% and especially preferably 18-22%, based on the mixture as a whole.
Preferred compounds of the formula O-17 are furthermore the compounds selected from the group of the compounds of the formulae

preferably in each case in amounts of ≥3% by weight, in particular ≥10% by weight.
i) Liquid-crystalline medium comprising one or more compounds of the formula BA

in which
alkenyl and alkenyl* in each case, independently of one another, denote a straight-chain alkenyl radical having 2-12 C atoms,

denotes

Z³ denotes a single
   bond, —CH₂CH₂—, —CH═CH—, —CF₂O—, —OCF₂—, —CH₂O—, —OCH₂—, —COO—, —OCO—, —C₂F₄—, —C₄H₈—, —CF═CF—.
Preferred compounds of the formula BA are indicated below:

Preferred mixtures comprise 5-60% by weight, preferably 10-55% by weight, in particular 20-50% by weight, of the compound of the formula O-17e

Preference is furthermore given to liquid-crystalline mixtures which comprise the compound O-17e

and the compound O-17i

preferably in total amounts of 3-60% by weight.
j) Preferred liquid-crystalline media according to the invention comprise one or more substances which contain a tetrahydronaphthyl or naphthyl unit, such as, for example, the compounds of the formulae N-1 to N-5,

in which R^{1N} and R^{2N} in each case, independently of one another, have the meanings indicated for R^{2A} in formula IIA, preferably denote straight-chain alkyl, straight-chain alkoxy or straight-chain alkenyl, and
Z¹ and Z² in each case, independently of one another,
   denote —C₂H₄-, —CH═CH—, —(CH₂)₄—, —(CH₂)₃O—, —O(CH₂)₃—, —CH═CHCH₂CH₂—, —CH₂CH₂CH═CH—, —CH₂O—, —OCH₂—, —COO—, —OCO—, —C₂F₄—, —CF═CF—, —CF═CH—, —CH═CF—, —CF₂O—, —OCF₂—, —CH₂— or a single bond.
k) Preferred mixtures comprise one or more compounds selected from the group of the difluorodibenzochroman compounds of the formula BC, chromans of the formula CR, fluorinated phenanthrenes of the formulae PH-1 and PH-2,

in which
R^{B1}, R^{B2}, R^{CR1}, R^{CR2}, R¹, R² in each case, independently of one another, have the meaning of R^{2A} in formula IIA. c is 0, 1 or 2. d is 1 or 2. R¹ and R² preferably, independently of one another, denote alkyl, alkoxy, alkenyl or alkenyloxy having 1 to 6 or 2 to 6 C atoms respectively.
The mixtures according to the invention preferably comprise the compounds of the formulae BC, CR, PH-1, PH-2, BF-1, BF-2, BS-1 and/or BS-2 in amounts of 3 to 20% by weight, in particular in amounts of 3 to 15% by weight.
Particularly preferred compounds of the formulae BC, CR, BF and BS are the compounds BC-1 to BC-7 and CR-1 to CR-5,

in which
alkyl and alkyl* in each case, independently of one another, denote a straight-chain alkyl radical having 1-6 C atoms, and
alkenyl and
alkenyl* in each case, independently of one another, denote a straight-chain alkenyl radical having 2-6 C atoms, and
alkenyloxy denotes a straight-chain alkenyloxy radical having 2-6 C atoms.
I) Preferred mixtures comprise one or more indane compounds of the formula in,

in which
R¹¹, R¹²
R¹³ in each case, independently of one another, denote a straight-chain alkyl, alkoxy, alkoxyalkyl or alkenyl radical having 1-6 C atoms or 2-6 C atoms respectively,
R¹² and R¹³ additionally denote halogen, preferably F,

denotes

i denotes 0, 1 or 2.
Preferred compounds of the formula In are the compounds of the formulae In-1 to In-16 indicated below:

Particular preference is given to the compounds of the formulae In-1, In-2, In-3 and In-4.
The compounds of the formula In and the sub-formulae In-1 to In-16 are preferably employed in the mixtures according to the invention in concentrations ≥5% by weight, in particular 5-30% by weight and very particularly preferably 5-25% by weight.
m) Preferred mixtures additionally comprise one or more compounds of the formulae L-1 to L-11,

in which
R, R¹ and R² in each case, independently of one another, have the meanings indicated for R^{2A} in Claim 3, (0) denotes an oxygen atom or a single bond, and alkyl denotes an alkyl radical having 1-6 C atoms. s denotes 1 or 2.
Particular preference is given to the compounds of the formulae L-1 and L-4, in particular L-4.
The compounds of the formulae L-1 to L-11 are preferably employed in concentrations of 5-50% by weight, in particular 5-40% by weight and very particularly preferably 10-40% by weight.
n) The medium additionally comprises one or more compounds selected from the following formulae:

In the compounds of the formulae Q-1 to Q-9, R^{Q} and X^{Q} in each case, independently of one another, have the meanings of R^{2A} in formula IIA. R^{Q} and X^{Q} preferably denote a straight-chain alkyl radical having 1-6 C atoms, in particular having 2-5 C atoms.

Particularly preferred mixture concepts are indicated below, where the preferred embodiments apply taken per se and in combination with one another. The acronyms used are explained in Tables 1-3 and in Table A. n and m here in each case, independently of one another, denote 1-6. All percentages are percent by weight and are based on the mixture as a whole.

The compounds of the formula EY are preferably employed in the liquid-crystalline medium in amounts of ≥1%, preferably ≥2%, based on the mixture as a whole. Particular preference is given to liquid-crystalline media which comprise 2-15%, very particularly preferably 5-10%, of the compounds of the formula EY.

The total concentration of the compounds of the formulae IA and IB in the liquid-crystalline media according to the invention is preferably 2-30%.

Particular preference is given to liquid-crystalline media which comprise 3-20%, very particularly preferably 5-15%, of the compounds of the formulae IA and IB.

The total concentration of the compounds of the formulae IA and/or IB and EY in the liquid-crystalline media according to the invention is preferably 5 to 40%, particularly preferably 7 to 20%, very particularly preferably 8 to 15%.

The total concentration of the compounds BF-1 and BF-2 and/or BS-1 and BS-2, preferably B-nO-Om and/or B(S)-nO-Om, in particular B-20-O5 and/or B(S)-20-O5, in the medium is preferably 15%, particularly preferably 5 to 13%.

The total concentration of the compounds of the formulae EY, IIA and/or IB and/or IIC in the liquid-crystalline media according to the invention is preferably 20-60%, particularly preferably 30 to 55%, very particularly preferably 35 to 50%.

The medium preferably comprises one or more compounds of the formula BS-1a.

The medium preferably comprises one or more compounds of the formulae BF-1a and BS-1a.

The medium preferably comprises one or more compounds of the formula IIA-2, in particular the compound CY-3-O2, in a total concentration of 1-20%, particularly preferably 2 to 15%, very particularly preferably 3-10%.

The medium preferably comprises one or more compounds of the formula IIB-11, particularly preferably PY-4-O2 and/or PY-1-O4, in a total concentration of 1-20%, particularly preferably 2 to 15%, very particularly preferably 3-10%.

The medium very particularly preferably comprises the compound Y-40-O4 or Y-20-O1V.

Preferred mixtures according to the invention furthermore comprise:
PYP-n-m, in particular PYP-2-3 and/or PYP-2-4,
preferably in concentrations >5%, in particular 8-30%,

and/or
CPY-n-Om, in particular CPY-2-O2 and/or CPY-3-O2, preferably in concentrations >5%, in particular 10-30%, based on the mixture as a whole,

and/or
CY-n-Om, preferably CY-3-O2, CY-3-O4, CY-5-O2 and/or CY-5-O4, in particular CY-3-O2, preferably in concentrations >2%, in particular 3-20%, particularly preferably 4-10%,

and/or
CCY-n-Om, preferably CCY-4-O2, CCY-3-O2, CCY-3-O3, CCY-3-O1 and/or CCY-5-O2, preferably in concentrations >5%, in particular 8-30%, particularly preferably 10-25%,

and/or
CLY-n-Om, preferably CLY-2-O4, CLY-3-O2 and/or CLY-3-O3, preferably in concentrations >5%, in particular 10-30%,

and/or
CK-n-F, preferably CK-3-F, CK-4-F and/or CK-5-F, preferably >5%, in particular 5-25%.

Preference is furthermore given to mixtures according to the invention which comprise the following mixture concepts:

(n and m in each case, independently of one another, denote 1-6.)
CPY-n-Om and CY-n-Om, preferably in concentrations of 10-80%, based on the mixture as a whole,

and/or
CPY-n-Om and CK-n-F, preferably in concentrations of 10-70%, based on the mixture as a whole,

and/or
CPY-n-Om and PY-n-Om, preferably CPY-2-O2 and/or CPY-3-O2 and PY-3-O2, preferably in concentrations of 10-40%, based on the mixture as a whole,

and/or
CPY-n-Om and CLY-n-Om, preferably in concentrations of 10-80%, based on the mixture as a whole,

and/or
PP-n-m, preferably PP-1-3 and/or PP-1-4, preferably in amounts of 2-10%

and/or
CC-3-V1, preferably in amounts of 3-15%

and/or
CC-V-V, preferably in amounts of 5-60%

and/or
CC-3-V, preferably in amounts of 5-60%

and/or
PGIY-n-Om, preferably in amounts of 3-15%,

and/or
CC-n-2V1, preferably in amounts of 3-20%.

The liquid-crystalline medium according to the invention preferably has a nematic phase from ≤−20° C. to ≥70° C., particularly preferably from ≤−30° C. to ≥80° C., very particularly preferably from ≤−40° C. to ≥90° C.

The expression “have a nematic phase” here means on the one hand that no smectic phase and no crystallisation are observed at low temperatures at the corresponding temperature and on the other hand that clearing still does not occur on heating from the nematic phase. The investigation at low temperatures is carried out in a flow viscometer at the corresponding temperature and checked by storage in test cells having a layer thickness corresponding to the electro-optical use for at least 100 hours. If the storage stability at a temperature of −20° C. in a corresponding test cell is 1000 h or more, the medium is referred to as stable at this temperature. At temperatures of −30° C. and −40° C., the corresponding times are 500 h and 250 h respectively. At high temperatures, the clearing point is measured by conventional methods in capillaries.

The liquid-crystal mixture preferably has a nematic phase range of at least 60 K and a flow viscosity v₂₀ of at most 30 mm²·s⁻¹ at 20° C.

The values of the birefringence Δn in the liquid-crystal mixture are generally between 0.070 and 0.160, preferably between 0.080 and 0.130, particularly preferably from 0.090 to 0.110.

The liquid-crystal mixture according to the invention has a Δε of −0.5 to −8.0, in particular −2.5 to −6.0, where Δε denotes the dielectric anisotropy. The rotational viscosity γ₁ at 20° C. is preferably ≤150 mPa·s, in particular ≤130 mPa·s.

The liquid-crystal media according to the invention have relatively small values for the threshold voltage (V₀). They are preferably in the range from 1.7 V to 3.0 V, particularly preferably ≤2.5 V and very particularly preferably ≤2.3 V.

For the present invention, the term “threshold voltage” relates to the capacitive threshold (V₀), also known as the Freedericks threshold, unless explicitly indicated otherwise.

In addition, the liquid-crystal media according to the invention have high values for the voltage holding ratio in liquid-crystal cells.

In general, liquid-crystal media having a low addressing voltage or threshold voltage exhibit a lower voltage holding ratio than those having a higher addressing voltage or threshold voltage and vice versa.

For the present invention, the term “dielectrically positive compounds” denotes compounds having a Δε>1.5, the term “dielectrically neutral compounds” denotes those where −1.5≤Δε≤1.5 and the term “dielectrically negative compounds” denotes those having Δε<−1.5. The dielectric anisotropy of the compounds is determined here by dissolving 10% of the compounds in a liquid-crystalline host and determining the capacitance of the resultant mixture in at least one test cell in each case having a layer thickness of 20 μm with homeotropic and with homogeneous surface alignment at 1 kHz. The measurement voltage is typically 0.5 V to 1.0 V, but is always lower than the capacitive threshold of the respective liquid-crystal mixture investigated.

All temperature values indicated for the present invention are in ° C.

The mixtures according to the invention are suitable for all VA-TFT applications, such as, for example, VAN, MVA, (S)-PVA, ASV, PSA (polymer sustained VA), SS (surface-stabilised)-VA and PS-VA (polymer stabilised VA). They are furthermore suitable for IPS (in-plane switching) and FFS (fringe field switching), in particular UB-FFS, having negative Δε.

The nematic liquid-crystal mixtures in the displays according to the invention generally comprise two components A and B, which themselves consist of one or more individual compounds.

Component A has a clearly negative dielectric anisotropy and gives the nematic phase a dielectric anisotropy of ≤−0.5. Besides one or more compounds of the formulae IA, IB and EY, it preferably comprises one or more compounds of the formulae IIA, IIB and/or IIC, furthermore one or more compounds of the formula III.

The proportion of component A is preferably between 45 and 100%, in particular between 60 and 100%.

For component A, one (or more) individual compound(s) which has (have) a value of Δε≤−0.8 is (are) preferably selected. This value must be more negative, the smaller the proportion A in the mixture as a whole.

Component B has pronounced nematogeneity and a flow viscosity of not greater than 30 mm²·s⁻¹, preferably not greater than 25 mm²·s⁻¹, at 20° C.

A multiplicity of suitable materials is known to the person skilled in the art from the literature. Particular preference is given to compounds of the formula III.

Particularly preferred individual compounds in component B are extremely low-viscosity nematic liquid crystals having a flow viscosity of not greater than 18 mm²·s⁻¹, preferably not greater than 12 mm²·s⁻¹, at 20° C.

Component B is monotropically or enantiotropically nematic, has no smectic phases and is able to prevent the occurrence of smectic phases down to very low temperatures in liquid-crystal mixtures. For example, if various materials of high nematogeneity are in each case added to a smectic liquid-crystal mixture, the nematogeneity of these materials can be compared through the degree of suppression of smectic phases that is achieved.

The mixture may optionally also comprise a component C, comprising compounds having a dielectric anisotropy of Δε≥1.5. These so-called positive compounds are generally present in a mixture of negative dielectric anisotropy in amounts of ≤20% by weight, based on the mixture as a whole.

The mixture according to the invention preferably comprises one or more compounds having a dielectric anisotropy of Δε≥1.5. These are preferably one or more compounds of the formula Q-1 as defined above, particularly preferably of the formula,

The compounds of the formula Q-1 are preferably employed in the mixtures according to the invention in total concentrations of 0.1-10%, particularly preferably 0.2-5%, very particularly preferably 0.3 to 2%.

In addition, these liquid-crystal phases may also comprise more than 18 components, preferably 18 to 25 components.

Besides one or more compounds of the formulae EY, IA and IB, the phases preferably comprise 4 to 15, in particular 5 to 12, and particularly preferably <10, compounds of the formulae IIA, IIB and/or IIC and optionally III.

The other constituents are preferably selected from nematic or nematogenic substances, in particular known substances, from the classes of the azoxybenzenes, benzylideneanilines, biphenyls, terphenyls, phenyl or cyclohexyl benzoates, phenyl or cyclohexyl cyclohexanecarboxylates, phenylcyclohexanes, cyclohexylbiphenyls, cyclohexylcyclohexanes, cyclohexylnaphthalenes, 1,4-biscyclohexylbiphenyls or cyclohexylpyrimidines, phenyl- or cyclohexyldioxanes, optionally halogenated stilbenes, benzyl phenyl ethers, tolans and substituted cinnamic acid esters.

The most important compounds which are suitable as constituents of liquid-crystal phases of this type can be characterised by the formula IV,

R²⁰-L-G-E-R²¹ IV

in which L and E in each case denote a carbo- or heterocyclic ring system from the group formed by 1,4-disubstituted benzene and cyclohexane rings, 4,4′-disubstituted biphenyl, phenylcyclohexane and cyclohexylcyclohexane systems, 2,5-disubstituted pyrimidine and 1,3-dioxane rings, 2,6-disubstituted naphthalene, di- and tetrahydronaphthalene, quinazoline and tetrahydroquinazoline,
G denotes —CH═CH— —N(O)═N—CH═
   —CH═CQ- —CH═N(O)—
   —C≡C— —CH₂—CH₂—
   —CO—O— —CH₂—O—
   —CO—S— —CH₂—S—
   —CH═N— —COO-Phe-COO—
   —CF₂O— —CF═CF—
   —OCF₂— —OCH₂—
   —(CH₂)₄— —(CH₂)₃O—

or a C—C single bond, Q denotes halogen, preferably chlorine, or —CN, and R²⁰ and R²¹ in each case denote alkyl, alkenyl, alkoxy, alkoxyalkyl or alkoxycarbonyloxy having up to 18, preferably up to 8, carbon atoms, or one of these radicals alternatively denotes CN, NC, NO₂, NCS, CF₃, SF₅, OCF₃, F, Cl or Br.

In most of these compounds, R²⁰ and R²¹ are different from one another, one of these radicals usually being an alkyl or alkoxy group. Other variants of the proposed substituents are also common. Many such substances or also mixtures thereof are commercially available. All these substances can be prepared by methods known from the literature.

It goes without saying for the person skilled in the art that the VA, IPS or FFS mixture according to the invention may also comprise compounds in which, for example, H, N, O, Cl and F have been replaced by the corresponding isotopes.

Polymerisable compounds, so-called reactive mesogens (RMs), for example as disclosed in U.S. Pat. No. 6,861,107, may furthermore be added to the mixtures according to the invention in concentrations of preferably 0.01-5% by weight, particularly preferably 0.2-2% by weight, based on the mixture. These mixtures may optionally also comprise an initiator, as described, for example, in U.S. Pat. No. 6,781,665. The initiator, for example Irganox-1076 from BASF, is preferably added to the mixture comprising polymerisable compounds in amounts of 0-1%. Mixtures of this type can be used for so-called polymer-stabilised VA (PS-VA) modes or PSA (polymer sustained alignment) modes, in which polymerisation of the reactive mesogens is intended to take place in the liquid-crystalline mixture. The prerequisite for this is that the liquid-crystal mixture itself comprises no polymerisable components which likewise polymerise under the conditions where the compounds of the formula M polymerise.

The polymerisation is preferably carried out under the following conditions: the polymerisable components are polymerised in a cell using a UV-A lamp of defined intensity for a defined period and applied voltage (typically 10 to 30 V alternating voltage, frequencies in the range from 60 Hz to 1 kHz). The UV-A light source employed is typically a metal-halide vapour lamp or high-pressure mercury lamp having an intensity of 50 mW/cm². These are conditions where, for example, liquid-crystalline compounds containing an alkenyl or alkenyloxy side chain, such as, for example, the compounds of the formula

where n=2, 3, 4, 5 or 6, do not polymerise.

In a preferred embodiment of the invention, the polymerisable compounds are selected from the compounds of the formula M

R^{Ma}-A^{M1}-(Z^{M1}-A^{M2})ₘ₁-R^{Mb} M

in which the individual radicals have the following meaning:
R^{Ma} and R^{Mb} in each case, independently of one another, denote P, P-Sp-, H, halogen, SF₅, NO₂, an alkyl, alkenyl or alkynyl group, where at least one of the radicals R^{Ma} and R^{Mb} preferably denotes or contains a group P or P-Sp-,
P denotes a polymerisable group,
Sp denotes a spacer group or a single bond,
A^{M1} and A^{M2} in each case, independently of one another, denote an aromatic, heteroaromatic, alicyclic or heterocyclic group, preferably having 4 to 25 ring atoms, preferably C atoms, which also includes or may contain annellated rings, and which may optionally be mono- or polysubstituted by L,
L denotes P, P-Sp-, OH, CH₂OH, F, Cl, Br, I, —CN, —NO₂, —NCO, —NCS, —OCN, —SCN, —C(═O)N(R^{X})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-, preferably P, P-Sp-, H, OH, CH₂OH, halogen, SF₅, NO₂, an alkyl, alkenyl or alkynyl group,
Y¹ denotes halogen,
Z^{M1} denotes —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—, —COO—, —OCO—CH═CH—, CR⁰R⁰⁰ or a single bond,
R⁰ and R⁰⁰ in each case, independently of one another, denote H or alkyl having 1 to 12 C atoms,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms,
m1 denotes 0, 1, 2, 3 or 4, and
n1 denotes 1, 2, 3 or 4,

where at least one, preferably one, two or three, particularly preferably one or two, from the group R^{Ma}, R^{Mb} and the substituents L present denotes a group P or P-Sp- or contains at least one group P or P-Sp-.

Particularly preferred compounds of the formula M are those in which
R^{Ma} and R^{Mb} in each case, independently of one another, denote P, P-Sp-, H, F, Cl, Br, I, —CN, —NO₂, —NCO, —NCS, —OCN, —SCN, SF₅ or straight-chain or branched alkyl having 1 to 25 C atoms, in which, in addition, one or more non-adjacent CH₂ groups may in each case be replaced, independently of one another, by -C(R⁰)═C(R⁰⁰)—, —C≡C—, —N(R⁰⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, Br, I, CN, P or P-Sp-, where at least one of the radicals R^{Ma} and R^{Mb} preferably denotes or contains a group P or P-Sp-,
A^{M1} and A^{M2} in each case, independently of one another, denote 1,4-phenylene, naphthalene-1,4-diyl, naphthalene-2,6-diyl, phenanthrene-2,7-diyl, anthracene-2,7-diyl, fluorene-2,7-diyl, coumarine, flavone, where, in addition, one or more CH groups in these groups may be replaced by N, cyclohexane-1,4-diyl, in which, in addition, one or more non-adjacent CH₂ groups may be replaced by O and/or S, 1,4-cyclohexenylene, bicyclo[1.1.1]-pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, where all these groups may be unsubstituted or mono- or polysubstituted by L,
L denotes P, P-Sp-, OH, CH₂OH, F, Cl, Br, I, —CN, —NO₂, —NCO, —NCS, —OCN, —SCN, —C(═O)N(R^{X})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-,
P denotes a polymerisable group,
Y¹ denotes halogen,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms.

Very particular preference is given to compounds of the formula M in which one of R^{Ma} and R^{Mb} or both denote P or P-Sp-.

Suitable and preferred RMs for use in liquid-crystalline media and PS-VA displays or PSA displays according to the invention are selected, for example, from the following formulae:

in which the individual radicals have the following meaning:
P¹, P² and P³ in each case, independently of one another, denote a polymerisable group, preferably having one of the meanings indicated above and below for P, particularly preferably an acrylate, methacrylate, fluoroacrylate, oxetane, vinyloxy or epoxy group,
Sp¹, Sp² and Sp³ in each case, independently of one another, denote a single bond or a spacer group, preferably having one of the meanings indicated above and below for Sp, and particularly preferably —(CH₂)ₚ₁—, —(CH₂)ₚ₁—O—, —(CH₂)ₚ₁—CO—O— or —(CH₂)ₚ₁—O—CO—O—, in which p1 is an integer from 1 to 12, and where in the last-mentioned groups the linking to the adjacent ring takes place via the 0 atom, where one of the radicals P¹-Sp¹-, P²—Sp²- and P³—Sp³- may also denote R^{aa},
R^{aa} denotes H, F, Cl, CN or straight-chain or branched alkyl having 1 to 25 C atoms, in which, in addition, one or more non-adjacent CH₂ groups may in each case be replaced, independently of one another, by —C(R⁰)═C(R⁰⁰)—, —C≡C—, —N(R⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, CN or P¹—Sp¹-, particularly preferably straight-chain or branched, optionally mono- or polyfluorinated, alkyl, alkoxy, alkenyl, alkynyl, alkylcarbonyl, alkoxycarbonyl or alkylcarbonyloxy having 1 to 12 C atoms (where the alkenyl and alkynyl radicals have at least two and the branched radicals at least three C atoms),
R⁰, R⁰⁰ in each case, independently of one another and on each occurrence identically or differently, denote H or alkyl having 1 to 12 C atoms,
R^{y} and R^{z} in each case, independently of one another, denote H, F, CH₃ or CF₃,
Z^{M1} denotes —O—, —CO—, —C(R^{Y}R^{z})— or —CF₂CF₂—,
Z^{M2} and Z^{M3} in each case, independently of one another, denote —CO—O—, —O—CO—, —CH₂O—, —OCH₂—, —CF₂O—, —OCF₂— or —(CH₂)ₙ—, where n is 2, 3 or 4,
L on each occurrence, identically or differently, denotes F, Cl, CN, or straight-chain or branched, optionally mono- or polyfluorinated, alkyl, alkoxy, alkenyl, alkynyl, alkylcarbonyl, alkoxycarbonyl or alkylcarbonyloxy having 1 to 12 C atoms, preferably F,
L′ and L″ in each case, independently of one another, denote H, F or Cl,
r denotes 0, 1, 2, 3 or 4,
s denotes 0, 1, 2 or 3,
t denotes 0, 1 or 2, and
x denotes 0 or 1.

Suitable polymerisable compounds are listed, for example, in Table D.

The liquid-crystalline media in accordance with the present application preferably comprise in total 0.1 to 10%, preferably 0.2 to 4.0%, particularly preferably 0.2 to 2.0%, of polymerisable compounds.

Particular preference is given to the polymerisable compounds of the formula M and of the formulae RM-1 to RM-121.

The mixtures according to the invention may furthermore comprise conventional additives, such as, for example, stabilisers, antioxidants, UV absorbers, nanoparticles, microparticles, etc.

The structure of the liquid-crystal displays according to the invention corresponds to the usual geometry, as described, for example, in EP-A 0 240 379.

The following examples are intended to explain the invention without limiting it. Above and below, percent data denote percent by weight; all temperatures are indicated in degrees Celsius.

Throughout the patent application, 1,4-cyclohexylene rings and 1,4-phenylene rings are depicted as follows:

The cyclohexylene rings are trans-1,4-cyclohexylene rings.

Throughout the patent application and in the working examples, the structures of the liquid-crystal compounds are indicated by means of acronyms.

Unless indicated otherwise, the transformation into chemical formulae is carried out in accordance with Tables 1-3. All radicals CₙH₂ₙ₊₁, CₘH₂ₘ₊₁ and Cₘ¹H_{2m′+1} or CₙH₂ₙ and CₘH₂ₘ are straight-chain alkyl radicals or alkylene radicals, in each case having n, m, m′ or z C atoms respectively. n, m, m′ and z in each case, independently of one another, denote 1, 2, 3, 4, 5, 6, 7, 8, 9, 10, 11 or 12, preferably 1, 2, 3, 4, 5 or 6. In Table 1 the ring elements of the respective compound are coded, in Table 2 the bridging members are listed and in Table 3 the meanings of the symbols for the left-hand or right-hand side chains of the compounds are indicated.

```
TABLE 1
Ring elements
  A
  AI
  B
  B(S)
  C
  D
  DI
  F
  FI
  G
  GI
  K
  L
  LI
  M
  MI
  N
  NI
  P
  S
  U
  UI
  Y
  Y(F, Cl)
  Y(Cl, F)
```

TABLE 2
Bridging members

| | | | |
|---|---|---|---|
| E | —CH₂CH₂— | | |
| V | —CH═CH— | | |
| T | —C≡C— | | |
| W | —CF₂CF₂— | | |
| Z | —COO— | ZI | —OCO— |
| O | —CH₂O— | OI | —OCH₂— |
| Q | —CF₂O— | QI | —OCF₂— |

TABLE 3
Side chains

| Left-hand side chain | | Right-hand side chain | |
|---|---|---|---|
| n- | CₙH₂ₙ₊₁— | -n | —CₙH₂ₙ₊₁ |
| nO- | CₙH₂ₙ₊₁—O— | -On | —O—CₙH₂ₙ₊₁ |
| V— | CH₂═CH— | —V | —CH═CH₂ |
| nV- | CₙH₂ₙ₊₁—CH═CH— | -nV | —CₙH₂ₙ—CH═CH₂ |
| Vn- | CH₂═CH—CₙH₂ₙ— | -Vn | —CH═CH—CₙH₂ₙ₊₁ |
| nVm- | CnH₂ₙ₊₁—CH═CH—CₘH₂ₘ— | -nVm | —CₙH₂ₙ—CH═CH—CₘH₂ₘ₊₁ |
| N— | N≡C— | —N | —C≡N |
| F— | F— | —F | —F |
| Cl— | Cl— | —Cl | —Cl |
| M- | CFH₂— | -M | —CFH₂ |
| D- | CF₂H— | -D | —CF₂H |
| T- | CF₃— | -T | —CF₃ |
| MO- | CFH₂O— | -OM | —OCFH₂ |
| DO- | CF₂HO— | -OD | —OCF₂H |
| TO- | CF₃O— | -OT | —OCF₃ |
| T- | CF₃— | -T | —CF₃ |
| A- | H—C≡C— | -A | —C≡C—H |

Besides the compounds of the formulae IIA and/or IIB and/or IIC and the compounds of the formulae I1, I2 and EY, the mixtures according to the invention preferably comprise one or more of the compounds from Table A indicated below.

```
TABLE A
  AIK-n-F
  AIY-n-Om
  AY-n-Om
  B-nO-Om
  B-n-Om
  B(S)-nO-Om
  B(S)-n-Om
  CB(S)-n-(O)m
  CB-n-m
  CB-n-Om
  PB-n-m
  PB-n-Om
  BCH-nm
  BCH-nmF
  CY(Cl, F)-n-Om
  CCY-n-Om
  CAIY-n-Om
  CCY(F, Cl)-n-Om
  CCY(Cl, F)-n-Om
  CCY-n-m
  CCY-V-m
  CCY-Vn-m
  CCY-n-OmV
  CBC-nmF
  CBC-nm
  CCP-V-m
  CCP-Vn-m
  CCP-nV-m
  CCP-n-m
  CPYP-n-(O)m
  CYYC-n-m
  CCYY-n-(O)m
  CCY-n-O2V
  CCH-nOm
  CY-n-m
  CCH-nm
  CC-n-V
  CC-n-V1
  CC-n-Vm
  CC-2V-V2
  CC-V-V
  CC-V-V1
  CVC-n-m
  CC-n-mV
  CCOC-n-m
  CP-nOmFF
  CH-nm
  CEY-n-Om
  CEY-V-n
  CVY-V-n
  CY-V-On
  CY-n-O1V
  CY-n-OC(CH₃)═CH₂
  CCN-nm
  CY-n-OV
  CCPC-nm
  CCY-n-zOm
  CPY-n-Om
  CPY-n-m
  CPY-V-Om
  CQY-n-(O)m
  CQIY-n-(O)m
  CCQY-n-(O)m
  CCQIY-n-(O)m
  CPQY-n-(O)m
  CPQIY-n-(O)m
  CPYG-n-(O)m
  CCY-V-Om
  CCY-V2-(O)m
  CCY-1V2-(O)m
  CCY-3V-(O)m
  CCVC-n-V
  CPYG-n-(O)m
  CPGP-n-m
  CY-nV-(O)m
  CENaph-n-Om
  COChrom-n-Om
  COChrom-n-m
  CCOChrom-n-Om
  CCOChrom-n-m
  CONaph-n-Om
  CCONaph-n-Om
  CCNaph-n-Om
  CNaph-n-Om
  CETNaph-n-Om
  CTNaph-n-Om
  CK-n-F
  CLY-n-Om
  CLY-n-m
  LYLI-n-m
  CYLI-n-m
  LY-n-(O)m
  COYOICC-n-m
  COYOIC-n-V
  CCOY-V-O2V
  CCOY-V-O3V
  COY-n-Om
  CCOY-n-Om
  D-nOmFF
  PCH-nm
  PCH-nOm
  PGIGI-n-F
  PGP-n-m
  PGIY-n-Om
  PP-n-m
  PP-n-Om
  PP-n-2V1
  PP-n-mVk
  PPGU-n-F
  PYP-n-mV
  PYP-n-m
  PYP-n-Om
  PPYY-n-m
  YPY-n-m
  YPY-n-mV
  PY-n-Om
  PY-n-m
  PY-V2-Om
  COY-1V-Om
  COY-V-Om
  CCOY-V-Om
  CCOY-1V-Om
  B-n-m
  DFDBC-n(O)-(O)m
  Y-nO-Om
  Y-nO-OmV
  Y-nO-OmVm′
  YG-n-Om
  YG-nO-Om
  YGI-n-Om
  YGI-nO-Om
  YY-n-Om
  YY-nO-Om
  YG-VnO-Om
  YG-nO-OmV
  YY-VnO-Om
```

The following abbreviations are used:

(n, m, m′, z: in each case, independently of one another, 1, 2, 3, 4, 5 or 6; (O)CₘH₂ₘ₊₁ means OCₘH₂ₘ₊₁ or CₘH₂ₘ₊₁)

The liquid-crystal mixtures which can be used in accordance with the invention are prepared in a manner which is conventional per se. In general, the desired amount of the components used in lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

By means of suitable additives, the liquid-crystal phases according to the invention can be modified in such a way that they can be employed in any type of, for example, ECB, VAN, IPS, GH or ASM-VA LCD display that has been disclosed to date.

The dielectrics may also comprise further additives known to the person skilled in the art and described in the literature, such as, for example, UV absorbers, antioxidants, nanoparticles and free-radical scavengers. For example, 0-15% of pleochroic dyes, stabilisers or chiral dopants may be added. Suitable stabilisers for the mixtures according to the invention are, in particular, those listed in Table B.

For example, 0-15% of pleochroic dyes, furthermore conductive salts, preferably ethyldimethyldodecylammonium 4-hexoxybenzoate, tetrabutylammonium tetraphenylboranate or complex salts of crown ethers (cf., for example, Haller et al., Mol. Cryst. Liq. Cryst., Volume 24, pages 249-258 (1973)), may be added in order to improve the conductivity or substances may be added in order to modify the dielectric anisotropy, the viscosity and/or the alignment of the nematic phases. Substances of this type are described, for example, in DE-A 22 09 127, 22 40 864, 23 21 632, 23 38 281, 24 50 088, 26 37 430 and 28 53 728.

```
TABLE B
  C 15
  CB 15
  CM 21
  R/S-811
  CM 44
  CM 45
  CM 47
  CN
  R/S-2011
  R/S-3011
  R/S-4011
  R/S-5011
  R/S-1011
```

Table B shows possible dopants which are generally added to the mixtures according to the invention. The mixtures preferably comprise O—10% by weight, in particular 0.01-5% by weight and particularly preferably 0.01-3% by weight of dopants. If the mixtures comprise only one dopant, it is employed in amounts of 0.01-4% by weight, preferably 0.1-1.0% by weight.

```
TABLE C



  n = 1, 2, 3, 4, 5, 6 or 7
  n = 1, 2, 3,4, 5, 6 or 7
  n = 1, 2, 3,4, 5, 6 or 7




































```

Stabilisers which can be added, for example, to the mixtures according to the invention in amounts of 0-10% by weight are shown below.

The medium according to the invention preferably comprises one or more stabilisers from Table D. The medium according to the invention particularly preferably comprises Tinuvin® 770 (bis(2,2,6,6-tetramethyl-4-piperidyl) sebacate), preferably in amounts of 0.001-5% by weight, based on the liquid-crystalline medium.

TABLE D

| | |
|---|---|
| | RM-1 |
| | RM-2 |
| | RM-3 |
| | RM-4 |
| | RM-5 |
| | RM-6 |
| | RM-7 |
| | RM-8 |
| | RM-9 |
| | RM-10 |
| | RM-11 |
| | RM-12 |
| | RM-13 |
| | RM-14 |
| | RM-15 |
| | RM-16 |
| | RM-17 |
| | RM-18 |
| | RM-19 |
| | RM-20 |
| | RM-21 |
| | RM-22 |
| | RM-23 |
| | RM-24 |
| | RM-25 |
| | RM-26 |
| | RM-27 |
| | RM-28 |
| | RM-29 |
| | RM-30 |
| | RM-31 |
| | RM-32 |
| | RM-33 |
| | RM-34 |
| | RM-35 |
| | RM-36 |
| | RM-37 |
| | RM-38 |
| | RM-39 |
| | RM-40 |
| | RM-41 |
| | RM-42 |
| | RM-43 |
| | RM-44 |
| | RM-45 |
| | RM-46 |
| | RM-47 |
| | RM-48 |
| | RM-49 |
| | RM-50 |
| | RM-51 |
| | RM-52 |
| | RM-53 |
| | RM-54 |
| | RM-55 |
| | RM-56 |
| | RM-57 |
| | RM-58 |
| | RM-59 |
| | RM-60 |
| | RM-61 |
| | RM-62 |
| | RM-63 |
| | RM-64 |
| | RM-65 |
| | RM-66 |
| | RM-67 |
| | RM-68 |
| | RM-69 |
| | RM-70 |
| | RM-71 |
| | RM-72 |
| | RM-73 |
| | RM-74 |
| | RM-75 |
| | RM-76 |
| | RM-77 |
| | RM-78 |
| | RM-79 |
| | RM-80 |
| | RM-81 |
| | RM-82 |
| | RM-83 |
| | RM-84 |
| | RM-85 |
| | RM-86 |
| | RM-87 |
| | RM-88 |
| | RM-89 |
| | RM-90 |
| | RM-91 |
| | RM-92 |
| | RM-93 |
| | RM-94 |
| | RM-95 |
| | RM-96 |
| | RM-97 |
| | RM-98 |
| | RM-99 |
| | RM-100 |
| | RM-101 |
| | RM-102 |
| | RM-103 |
| | RM-104 |
| | RM-105 |
| | RM-106 |
| | RM-107 |
| | RM-108 |
| | RM-109 |
| | RM-110 |
| | RM-111 |
| | RM-112 |
| | RM-113 |
| | RM-114 |
| | RM-115 |
| | RM-116 |
| | RM-117 |
| | RM-118 |
| | RM-119 |
| | RM-120 |
| | RM-121 |
| | RM-122 |
| | RM-123 |
| | RM-124 |
| | RM-125 |
| | RM-126 |
| | RM-127 |
| | RM-128 |
| | RM-129 |
| | RM-130 |
| | RM-131 |

Table D shows example compounds which can preferably be used as reactive mesogenic compounds in the LC media in accordance with the present invention. If the mixtures according to the invention comprise one or more reactive compounds, they are preferably employed in amounts of 0.01-5% by weight. It may also be necessary to add an initiator or a mixture of two or more initiators for the polymerisation. The initiator or initiator mixture is preferably added in amounts of 0.001-2% by weight, based on the mixture. A suitable initiator is, for example, Irgacure (BASF) or Irganox (BASF).

In a preferred embodiment, the mixtures according to the invention comprise one or more polymerisable compounds, preferably selected from the polymerisable compounds of the formulae RM-1 to RM-131. Media of this type are suitable, in particular, for PS-VA, PS-FFS and PS-IPS applications. Of the reactive mesogens shown in Table D, compounds RM-1, RM-4, RM-8, RM-17, RM-19, RM-35, RM-37, RM-43, RM-47, RM-49, RM-51, RM-59, RM-69, RM-71, RM-83, RM-97, RM-98, RM-104, RM-112, RM-115 and RM-116 are particularly preferred.

The reactive mesogens or the polymerisable compounds of the formula M and of the formulae RM-1 to RM-131 are furthermore suitable as stabilisers. In this case, the polymerisable compounds are not polymerised, but instead are added to the liquid-crystalline medium in concentrations >1%.

### WORKING EXAMPLES

The following examples are intended to explain the invention without limiting it. In the examples, m.p. denotes the melting point and C denotes the clearing point of a liquid-crystalline substance in degrees Celsius; boiling points are denoted by b.p. Furthermore:

C denotes crystalline solid state, S denotes smectic phase (the index denotes the phase type), N denotes nematic state, Ch denotes cholesteric phase, I denotes isotropic phase, T_{g} denotes glass-transition temperature. The number between two symbols indicates the conversion temperature in degrees Celsius.

The host mixture used for determination of the optical anisotropy Δn of the compounds of the formula I is the commercial mixture ZLI-4792 (Merck KGaA). The dielectric anisotropy Δε is determined using commercial mixture ZLI-2857. The physical data of the compound to be investigated are obtained from the change in the dielectric constants of the host mixture after addition of the compound to be investigated and extrapolation to 100% of the compound employed. In general, 10% of the compound to be investigated are dissolved in the host mixture, depending on the solubility.

Unless indicated otherwise, parts or percent data denote parts by weight or percent by weight.

Above and below,
Vₒ denotes the threshold voltage, capacitive [V] at 20° C.
Δn denotes the optical anisotropy measured at 20° C. and 589 nm
Δε denotes the dielectric anisotropy at 20° C. and 1 kHz
T_{(N,I)} denotes the clearing point [° C.]
K₁ denotes the elastic constant, “splay” deformation at 20° C. [pN]
K₃ denotes the elastic constant, “bend” deformation at 20° C. [pN]
γ₁ denotes the rotational viscosity measured at 20° C. [mPa·s], determined by the rotation method in a magnetic field
LTS denotes the low-temperature stability (nematic phase), determined in bulk samples.

The display used for measurement of the threshold voltage has two plane-parallel outer plates at a separation of 20 μm and electrode layers with alignment layers comprising SE-1211 (Nissan Chemicals) on top on the insides of the outer plates, which effect a homeotropic alignment of the liquid crystals.

In order to determine the low-temperature stability (nematic phase), samples (typically 2 g) are stored in glass vials at the temperature indicated and investigated visually daily for the occurrence of crystallisation or smectic phases. The time indicated in the tables is the time after which a phase conversion was observed for the first time. The test is terminated after 1000 h and LTS: 1000 noted.

All concentrations in this application, unless explicitly indicated otherwise, relate to the corresponding mixture or mixture component. All physical properties are determined in accordance with “Merck Liquid Crystals, Physical Properties of Liquid Crystals”, status November 1997, Merck KGaA, Germany, and apply for a temperature of 20° C., unless explicitly indicated otherwise.

### Example M-1

| | | | |
|---|---|---|---|
| CCH-23 | 15.0 | Clearing point [° C.]: | 74 |
| CCH-34 | 6.0 | Δn [589 nm, 20° C.]: | 0.0952 |
| CCH-35 | 6.0 | nₑ [589 nm, 20° C.]: | 1.5788 |
| CCP-3-1 | 18.0 | nₒ [589 nm, 20° C.]: | 1.4836 |
| BCH-32 | 4.0 | ε_{∥} [1 kHz, 20° C.]: | 3.5 |
| CCY-3-O1 | 7.0 | ε_{⊥} [1 kHz, 20° C.]: | 6.1 |
| CCY-3-O2 | 11.0 | Δε [1 kHz, 20° C.]: | −2.6 |
| CPY-3-O2 | 6.0 | K₁ [pN, 20° C.]: | 15.1 |
| PCH-302 | 2.0 | K₃ [pN, 20° C.]: | 15.2 |
| COY-3-O2 | 5.0 | K₃/K₁ [pN, 20° C.]: | 1.01 |
| PY-3-O2 | 6.0 | V₀ [V, 20° C.]: | 2.56 |
| Y-4O-O4 | 8.0 | γ₁ [mPa s, 20° C.]: | 93 |
| PP-1-3 | 6.0 | LTS bulk [h, −20° C.]: | 264 |
| Σ | 100.0 | LTS bulk [h, −30° C.]: | 72 |

### Example P1

For the preparation of a PS-VA mixture, 99.7% of the mixture in accordance with Example M-1 are mixed with 0.3% of the polymerisable compound of the formula

### Example P2

For the preparation of a PS-VA mixture, 99.7% of the mixture in accordance with Example M-1 are mixed with 0.3% of the polymerisable compound of the formula

### Example P3

For the preparation of a PS-VA mixture, 99.75% of the mixture in accordance with Example M-1 are mixed with 0.25% of the polymerisable compound of the formula

### Example P4

For the preparation of a PS-VA mixture, 99.75% of the mixture in accordance with Example M-1 are mixed with 0.25% of the polymerisable compound of the formula

### Example P5

For the preparation of a PS-VA mixture, 99.7% of the mixture in accordance with Example M-1 are mixed with 0.3% of the polymerisable compound of the formula

### Example P6

For the preparation of a PS-VA mixture, 99.7% of the mixture in accordance with Example M-1 are mixed with 0.3% of the polymerisable compound of the formula

### Example P7

For the preparation of a PS-VA mixture, 99.75% of the mixture in accordance with Example M-1 are mixed with 0.25% of the polymerisable compound of the formula

### Example P8

For the preparation of a PS-VA mixture, 99.75% of the mixture in accordance with Example M-1 are mixed with 0.25% of the polymerisable compound of the formula

### Example P9

For the preparation of a PS-VA mixture, 99.75% of the mixture in accordance with Example M-1 are mixed with 0.25% of the polymerisable compound of the formula

### Example M-2

| | | | |
|---|---|---|---|
| CCH-23 | 15.0 | Clearing point [° C.]: | 73 |
| CCH-34 | 6.0 | Δn [589 nm, 20° C.]: | 0.0946 |
| CCH-35 | 6.0 | nₑ [589 nm, 20° C.]: | 1.5791 |
| CCP-3-1 | 14.0 | nₒ [589 nm, 20° C.]: | 1.4845 |
| CCP-3-3 | 5.5 | ε_{∥} [1 kHz, 20° C.]: | 3.4 |
| BCH-32 | 1.5 | ε_{⊥} [1 kHz, 20° C.]: | 5.9 |
| CCY-3-O1 | 7.0 | Δε [1 kHz, 20° C.]: | −2.5 |
| CCY-3-O2 | 11.0 | K₁ [pN, 20° C.]: | 14.9 |
| CCY-4-O2 | 1.5 | K₃ [pN, 20° C.]: | 14.5 |
| CPY-3-O2 | 5.0 | K₃/K₁ [pN, 20° C.]: | 0.97 |
| COY-3-O2 | 5.0 | V₀ [V, 20° C.]: | 2.56 |
| PY-4-O2 | 3.0 | γ₁ [mPa s, 20° C.]: | 92 |
| PY-1-O4 | 3.5 | LTS bulk [h, −20° C.]: | 1000 |
| Y-4O-O4 | 7.0 | LTS bulk [h, −30° C.]: | 1000 |
| PP-1-3 | 9.0 | | |
| Σ | 100.0 | | |

### Example P10

For the preparation of a PS-VA mixture, 99.7% of the mixture in accordance with Example M-2 are mixed with 0.3% of the polymerisable compound of the formula

### Example P11

For the preparation of a PS-VA mixture, 99.7% of the mixture in accordance with Example M-2 are mixed with 0.3% of the polymerisable compound of the formula

### Example P12

For the preparation of a PS-VA mixture, 99.75% of the mixture in accordance with Example M-2 are mixed with 0.25% of the polymerisable compound of the formula

### Example P13

For the preparation of a PS-VA mixture, 99.75% of the mixture in accordance with Example M-2 are mixed with 0.25% of the polymerisable compound of the formula

### Example P14

For the preparation of a PS-VA mixture, 99.7% of the mixture in accordance with Example M-2 are mixed with 0.3% of the polymerisable compound of the formula

### Example P15

For the preparation of a PS-VA mixture, 99.7% of the mixture in accordance with Example M-2 are mixed with 0.3% of the polymerisable compound of the formula

### Example P16

For the preparation of a PS-VA mixture, 99.75% of the mixture in accordance with Example M-2 are mixed with 0.25% of the polymerisable compound of the formula

### Example P17

For the preparation of a PS-VA mixture, 99.75% of the mixture in accordance with Example M-2 are mixed with 0.25% of the polymerisable compound of the formula

### Example P18

For the preparation of a PS-VA mixture, 99.75% of the mixture in accordance with Example M-2 are mixed with 0.25% of the polymerisable compound of the formula

### Example M-3

| | | | |
|---|---|---|---|
| Y-4O-O4 | 5.5 | Clearing point [° C.]: | 74 |
| PY-1-O4 | 5.5 | Δn [589 nm, 20° C.]: | 0.1068 |
| CCOY-2-O2 | 4.5 | nₑ [589 nm, 20° C.]: | 1.5966 |
| COY-3-O2 | 3.0 | nₒ [589 nm, 20° C.]: | 1.4898 |
| CPY-2-O2 | 7.0 | ε_{∥} [1 kHz, 20° C.]: | 3.3 |
| CPY-3-O2 | 10.0 | ε_{⊥} [1 kHz, 20° C.]: | 5.3 |
| CCH-23 | 17.0 | Δε [1 kHz, 20° C.]: | −2.0 |
| CCH-34 | 5.0 | K₁ [pN, 20° C.]: | 14.8 |
| CCH-35 | 4.0 | K₃ [pN, 20° C.]: | 13.8 |
| PCH-302 | 3.5 | K₃/K₁ [pN, 20° C.]: | 0.93 |
| BCH-32 | 8.5 | V₀ [V, 20° C.]: | 2.78 |
| CCP-3-1 | 14.0 | γ₁ [mPa s, 20° C.]: | 88 |
| CCP-3-3 | 4.0 | LTS bulk [h, −20° C.]: | 1000 |
| PP-1-3 | 4.5 | LTS bulk [h, −30° C.]: | 1000 |
| PP-1-4 | 4.0 | | |
| Σ | 100.0 | | |

### Example P19

For the preparation of a PS-VA mixture, 99.7% of the mixture in accordance with Example M-3 are mixed with 0.3% of the polymerisable compound of the formula

### Example P20

For the preparation of a PS-VA mixture, 99.7% of the mixture in accordance with Example M-3 are mixed with 0.3% of the polymerisable compound of the formula

### Example P21

For the preparation of a PS-VA mixture, 99.75% of the mixture in accordance with Example M-3 are mixed with 0.25% of the polymerisable compound of the formula

### Example P22

For the preparation of a PS-VA mixture, 99.75% of the mixture in accordance with Example M-3 are mixed with 0.25% of the polymerisable compound of the formula

### Example P23

For the preparation of a PS-VA mixture, 99.7% of the mixture in accordance with Example M-3 are mixed with 0.3% of the polymerisable compound of the formula

### Example P24

For the preparation of a PS-VA mixture, 99.7% of the mixture in accordance with Example M-3 are mixed with 0.3% of the polymerisable compound of the formula

### Example P25

For the preparation of a PS-VA mixture, 99.75% of the mixture in accordance with Example M-3 are mixed with 0.25% of the polymerisable compound of the formula

### Example P26

For the preparation of a PS-VA mixture, 99.75% of the mixture in accordance with Example M-3 are mixed with 0.25% of the polymerisable compound of the formula

### Example P27

For the preparation of a PS-VA mixture, 99.75% of the mixture in accordance with Example M-3 are mixed with 0.25% of the polymerisable compound of the formula

### Example M-4

| | | | |
|---|---|---|---|
| CY-3-O2 | 7.0 | Clearing point [° C.]: | 84 |
| CEY-3-O2 | 16.0 | Δn [589 nm, 20° C.]: | 0.1030 |
| CCY-3-O1 | 10.0 | nₑ [589 nm, 20° C.]: | 1.5813 |
| CCY-3-O2 | 11.0 | nₒ [589 nm, 20° C.]: | 1.4783 |
| CPY-3-O2 | 12.0 | ε_{∥} [1 kHz, 20° C.]: | 4.0 |
| CC-3-V | 22.0 | ε_{⊥} [1 kHz, 20° C.]: | 9.3 |
| CCEY-3-O2 | 13.5 | Δε [1 kHz, 20° C.]: | −5.3 |
| Y-4O-O4 | 3.0 | K₁ [pN, 20° C.]: | 15.2 |
| PGIY-2-O4 | 5.5 | K₃ [pN, 20° C.]: | 19.0 |
| Σ | 100.0 | K₃/K₁ [pN, 20° C.]: | 1.25 |
| | | V₀ [V, 20° C.]: | 2.00 |
| | | γ₁ [mPa s, 20° C.]: | 166 |
| | | LTS bulk [h, −20° C.]: | 1000 |
| | | LTS bulk [h, −30° C.]: | 72 |

### Example M-5

| | | | |
|---|---|---|---|
| CCH-23 | 15.0 | Clearing point [° C.]: | 74 |
| CCH-34 | 6.0 | Δn [589 nm, 20° C.]: | 0.0961 |
| CCH-35 | 6.0 | nₑ [589 nm, 20° C.]: | 1.5799 |
| CCP-3-1 | 13.0 | nₒ [589 nm, 20° C.]: | 1.4838 |
| CCP-3-3 | 4.5 | ε_{∥} [1 kHz, 20° C.]: | 3.4 |
| BCH-32 | 4.5 | ε_{⊥} [1 kHz, 20° C.]: | 6.0 |
| CCOY-3-O2 | 6.0 | Δε [1 kHz, 20° C.]: | −2.6 |
| CCY-3-O2 | 10.0 | K₁ [pN, 20° C.]: | 15.0 |
| CPY-3-O2 | 8.0 | K₃ [pN, 20° C.]: | 15.2 |
| PCH-302 | 3.0 | K₃/K₁ [pN, 20° C.]: | 1.01 |
| COY-3-O2 | 5.0 | V₀ [V, 20° C.]: | 2.58 |
| PY-3-O2 | 4.0 | γ₁ [mPa s, 20° C.]: | 94 |
| Y-4O-O4 | 8.0 | LTS bulk [h, −30° C.]: | 1000 |
| PP-1-3 | 7.0 | | |
| Σ | 100.0 | | |

### Example M-6

| | | | |
|---|---|---|---|
| CCH-23 | 15.0 | Clearing point [° C.]: | 73 |
| CCH-34 | 6.0 | Δn [589 nm, 20° C.]: | 0.0953 |
| CCH-35 | 6.0 | Δε [1 kHz, 20° C.]: | −2.5 |
| CCP-3-1 | 18.0 | K₁ [pN, 20° C.]: | 14.4 |
| BCH-32 | 4.0 | K₃ [pN, 20° C.]: | 15.1 |
| CCY-3-O1 | 7.0 | V₀ [V, 20° C.]: | 2.53 |
| CCY-3-O2 | 11.0 | γ₁ [mPa s, 20° C.]: | 85 |
| CPY-3-O2 | 6.0 | | |
| PCH-302 | 2.0 | | |
| COY-3-O2 | 5.0 | | |
| PY-3-O2 | 6.0 | | |
| Y-2O-O1V | 8.0 | | |
| PP-1-3 | 6.0 | | |
| Σ | 100.0 | | |

### Example P28

For the preparation of a PS-VA mixture, 99.7% of the mixture in accordance with Example M-6 are mixed with 0.3% of the polymerisable compound of the formula

### Example P29

For the preparation of a PS-VA mixture, 99.7% of the mixture in accordance with Example M-6 are mixed with 0.3% of the polymerisable compound of the formula

### Example P30

For the preparation of a PS-VA mixture, 99.75% of the mixture in accordance with Example M-6 are mixed with 0.25% of the polymerisable compound of the formula

### Example P31

For the preparation of a PS-VA mixture, 99.75% of the mixture in accordance with Example M-6 are mixed with 0.25% of the polymerisable compound of the formula

### Example P32

For the preparation of a PS-VA mixture, 99.7% of the mixture in accordance with Example M-6 are mixed with 0.3% of the polymerisable compound of the formula

### Example P33

For the preparation of a PS-VA mixture, 99.7% of the mixture in accordance with Example M-6 are mixed with 0.3% of the polymerisable compound of the formula

### Example P34

For the preparation of a PS-VA mixture, 99.75% of the mixture in accordance with Example M-6 are mixed with 0.25% of the polymerisable compound of the formula

### Example P35

For the preparation of a PS-VA mixture, 99.75% of the mixture in accordance with Example M-6 are mixed with 0.25% of the polymerisable compound of the formula

### Example P36

For the preparation of a PS-VA mixture, 99.75% of the mixture in accordance with Example M-6 are mixed with 0.25% of the polymerisable compound of the formula

### Example M-7

| | | | |
|---|---|---|---|
| Y-2O-O1V | 5.5 | Clearing point [° C.]: | 73.5 |
| PY-1-O4 | 5.5 | Δn [589 nm, 20° C.]: | 0.1068 |
| CCOY-2-O2 | 4.5 | Δε [1 kHz, 20° C.]: | −1.9 |
| COY-3-O2 | 3.0 | K₁ [pN, 20° C.]: | 14.3 |
| CPY-2-O2 | 7.0 | K₃ [pN, 20° C.]: | 13.8 |
| CPY-3-O2 | 10.0 | V₀ [V, 20° C.]: | 2.76 |
| CCH-23 | 17.0 | γ₁ [mPa s, 20° C.]: | 83 |
| CCH-34 | 5.0 | | |
| CCH-35 | 4.0 | | |
| PCH-302 | 3.5 | | |
| BCH-32 | 8.5 | | |
| CCP-3-1 | 14.0 | | |
| CCP-3-3 | 4.0 | | |
| PP-1-3 | 4.5 | | |
| PP-1-4 | 4.0 | | |
| Σ | 100.0 | | |

### Example M-8

| | | | |
|---|---|---|---|
| CY-3-O2 | 0.0 | Clearing point [° C.]: | 83.5 |
| CEY-3-O2 | 0.0 | Δn [589 nm, 20° C.]: | 0.1030 |
| CCY-3-O1 | 0.0 | Δε [1 kHz, 20° C.]: | −5.3 |
| CCY-3-O2 | 0.0 | K₁ [pN, 20° C.]: | 15.0 |
| CPY-3-O2 | 0.0 | K₃ [pN, 20° C.]: | 19.0 |
| CC-3-V | 0.0 | V₀ [V, 20° C.]: | 1.99 |
| CCEY-3-O2 | 0.0 | γ₁ [mPa s, 20° C.]: | 163 |
| Y-2O-O1V | 0.0 | | |
| PGIY-2-O4 | 0.0 | | |
| Σ | 100.0 | | |

### Example M-9

| | | | |
|---|---|---|---|
| CCH-23 | 15.0 | Clearing point [° C.]: | 73 |
| CCH-34 | 6.0 | Δn [589 nm, 20° C.]: | 0.0962 |
| CCH-35 | 6.0 | Δε [1 kHz, 20° C.]: | −2.5 |
| CCP-3-1 | 13.0 | K₁ [pN, 20° C.]: | 14.3 |
| CCP-3-3 | 4.5 | K₃ [pN, 20° C.]: | 15.1 |
| BCH-32 | 4.5 | V₀ [V, 20° C.]: | 2.55 |
| CCOY-3-O2 | 6.0 | γ₁ [mPa s, 20° C.]: | 86 |
| CCY-3-O2 | 10.0 | | |
| CPY-3-O2 | 8.0 | | |
| PCH-302 | 3.0 | | |
| COY-3-O2 | 5.0 | | |
| PY-3-O2 | 4.0 | | |
| Y-2O-O1V | 8.0 | | |
| PP-1-3 | 7.0 | | |
| Σ | 100.0 | | |

### Example M-10

| | | | |
|---|---|---|---|
| CCEY-3-O2 | 5.0 | Clearing point [° C.]: | 75.5 |
| CLY-3-O3 | 4.5 | Δn [589 nm, 20° C.]: | 0.0962 |
| CLY-4-O2 | 5.0 | ε_{∥} [1 kHz, 20° C.]: | 3.4 |
| CPY-3-O2 | 6.0 | ε_{⊥}[1 kHz, 20° C.]: | 6.1 |
| PGIY-2-O4 | 6.0 | Δε [1 kHz, 20° C.]: | −2.7 |
| PYP-2-3 | 0.5 | K₁ [pN, 20° C.]: | 14.6 |
| B(S)-2O-O4 | 4.0 | K₃ [pN, 20° C.]: | 14.6 |
| B(S)-2O-O5 | 5.0 | V₀ [V, 20° C.]: | 2.45 |
| B(S)-2O-O6 | 3.0 | γ₁ [mPa s, 20° C.]: | 68 |
| B-2O-O5 | 1.0 | LTS bulk [h, −20° C.]: | 168 |
| CC-3-V | 50.0 | | |
| CC-3-V1 | 6.0 | | |
| CCH-23 | 2.5 | | |
| Y-4O-O4 | 1.5 | | |
| Σ | 100.0 | | |

### Example P37

For the preparation of a PS-VA mixture, 99.7% of the mixture in accordance with Example M-10 are mixed with 0.3% of the polymerisable compound of the formula

### Example P38

For the preparation of a PS-VA mixture, 99.7% of the mixture in accordance with Example M-10 are mixed with 0.3% of the polymerisable compound of the formula

### Example P39

For the preparation of a PS-VA mixture, 99.75% of the mixture in accordance with Example M-10 are mixed with 0.25% of the polymerisable compound of the formula

### Example P40

For the preparation of a PS-VA mixture, 99.75% of the mixture in accordance with Example M-10 are mixed with 0.25% of the polymerisable compound of the formula

### Example P41

For the preparation of a PS-VA mixture, 99.7% of the mixture in accordance with Example M-10 are mixed with 0.3% of the polymerisable compound of the formula

### Example P42

For the preparation of a PS-VA mixture, 99.7% of the mixture in accordance with Example M-10 are mixed with 0.3% of the polymerisable compound of the formula

### Example P43

For the preparation of a PS-VA mixture, 99.75% of the mixture in accordance with Example M-10 are mixed with 0.25% of the polymerisable compound of the formula

### Example P44

For the preparation of a PS-VA mixture, 99.75% of the mixture in accordance with Example M-10 are mixed with 0.25% of the polymerisable compound of the formula

### Example P45

For the preparation of a PS-VA mixture, 99.75% of the mixture in accordance with Example M-10 are mixed with 0.25% of the polymerisable compound of the formula

### Example M11

| | | | |
|---|---|---|---|
| CLY-2-O4 | 5.0 | Clearing point [° C.]: | 93 |
| CLY-3-O2 | 7.0 | Δn [589 nm, 20° C.]: | 0.1015 |
| CLY-3-O3 | 5.0 | ε_{∥} [1 kHz, 20° C.]: | 3.5 |
| CLY-4-O2 | 5.0 | ε_{⊥}[1 kHz, 20° C.]: | 7.5 |
| CLY-5-O2 | 8.0 | Δε [1 kHz, 20° C.]: | −4.0 |
| CCEY-3-O2 | 7.5 | K₁ [pN, 20° C.]: | 18.3 |
| PGIY-2-O4 | 3.0 | K₃ [pN, 20° C.]: | 17.9 |
| B(S)-2O-O4 | 4.0 | V₀ [V, 20° C.]: | 2.45 |
| B(S)-2O-O5 | 5.0 | γ₁ [mPa s, 20° C.]: | 112 |
| B(S)-2O-O6 | 3.0 | LTS bulk [h, −20° C.]: | 552 |
| CC-3-V | 38.0 | | |
| CC-3-V1 | 7.0 | | |
| Y-4O-O4 | 2.5 | | |
| Σ | 100.0 | | |

### Example M12

| | | | |
|---|---|---|---|
| CCP-3-1 | 7.0 | Clearing point [° C.]: | 92.5 |
| CCP-V-1 | 11.0 | Δn [589 nm, 20° C.]: | 0.1007 |
| CCP-V2-1 | 6.0 | ε_{∥} [1 kHz, 20° C.]: | 3.6 |
| CCOY-3-O2 | 6.0 | ε_{⊥} [1 kHz, 20° C.J: | 7.4 |
| CLY-3-O2 | 4.0 | Δε [1 kHz, 20° C.]: | −3.8 |
| CLY-4-O2 | 5.0 | K₁ [pN, 20° C.]: | 18.4 |
| CLY-5-O2 | 4.0 | K₃ [pN, 20° C.]: | 17.1 |
| PGIY-2-O4 | 3.0 | V₀ [V, 20° C.]: | 2.27 |
| B(S)-2O-O4 | 4.0 | γ₁ [mPa s, 20° C.]: | 124 |
| B(S)-2O-O5 | 4.0 | | |
| B(S)-2O-O6 | 4.0 | | |
| CC-3-V1 | 6.2 | | |
| CCH-23 | 18.0 | | |
| CCH-34 | 5.0 | | |
| CY-3-O2 | 9.0 | | |
| Y-4O-O4 | 3.5 | | |
| CCQU-3-F | 0.3 | | |
| Σ | 100.0 | | |

The preceding examples can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever. From the description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German application No. DE 10 2018 005 326.2, filed Jun. 21, 2018, are incorporated by reference herein.

1. A liquid-crystalline medium, comprising one or more compounds of formula EY
and
one or more compounds selected from the group consisting of the compounds of formulae IA and IB
and/or one or more compounds selected from the group consisting of the compounds of formulae BF-1, BF-2, BS-1 and BS-2:
in which
R¹, R^{1*},
R^{1A}, R^{1B} and R^{B} denote, each independently, H, an alkyl or alkenyl radical having up to 15 C atoms, which is unsubstituted, monosubstituted by CN or CF₃ or at least monosubstituted by halogen, in which one or more CH₂ groups may be replaced by —O—, —S—,
—C≡C—, —CF₂O—, —OCF₂—, —OC—O— or —O—CO— in such a way that O atoms are not linked directly to one another,
on each occurrence, identically or differently, denotes,
L¹, L², independently of one another, denote F or Cl,
L³, L⁴ in each case, independently of one another, denote F, Cl, CF₃ or CHF₂,
L⁵ denotes H or methyl,
alkyl denotes a straight-chain alkyl adical having 1 to 6 C atoms,
Z^{2A} and Z^{2B} in each case, independently of one another, denote —CH₂CH₂—, —CH═CH—, —CF₂O—, —OCF₂—, —CH₂O—, —O CH₂—, —COO—, —OCO—, —C₂F₄—, —CF═CF— or —CH═CHCH₂O—,
(O) denotes O or a single bond,
p denotes 1 or 2,
q denotes 0 or 1,
c denotes 0, 1 or 2, and
d denotes 1 or 2.

2. The liquid-crystalline medium according to claim 1, which comprises one or more compounds of formula IA or IB in which Z^{2A} and Z^{2B}, independently of one another, denote —CH₂CH₂—, —CH₂O— or —OCH₂—.

3. The liquid-crystalline medium according to claim 1, which comprises one or more compounds of formula EY in which
R¹ denotes an alkenyloxy radical having 2 to 7 C atoms, and
R^{1*} denotes an alkoxy radical having 1 to 6 C atoms or an alkenyloxy radical having 2 to 7 C atoms.

4. The liquid-crystalline medium according to claim 1, which comprises one or more compounds of formula EY selected from the group consisting of the compounds of the following formulae:

5. The liquid-crystalline medium according to claim 4, which comprises the compound EY-15.

6. The liquid-crystalline medium according to claim 1, further comprising one or more compounds selected from the group consisting of the compounds of formulae IIA, IIB and IIC,
in which
R^{2A}, R^{2B} and R^{2C} in each case, independently of one another, denote H, an alkyl or alkenyl radical having up to 15 C atoms, which is unsubstituted, monosubstituted by CN or CF₃ or at least monosubstituted by halogen, in which one or more CH₂ groups may be replaced by —O—, —S—,
—C≡C—, —CF₂O—, —OCF₂—, —OC—O— or —O—CO— in such a way that O atoms are not linked directly to one another,
L¹⁻⁴ in each case, independently of one another, denote F, Cl, CF₃ or CHF₂,
L⁵ denotes H or methyl,
p denotes 1 or 2,
q denotes 0 or 1,
v denotes an integer from 1 to 6, and
(O) denotes an oxygen atom or a single bond.
with the proviso that the compounds of formulae IA and IB are excluded.

7. The liquid-crystalline medium according to claim 6, which comprises one or more compounds of formula IIB, in which q is equal to 0.

8. The liquid-crystalline medium according to claim 1, further comprising one or more compounds selected from the group consisting of the compounds B-1, B-2, B3 and B-4:
in which
alkyl and alkyl* in each case, independently of one another, denote a straight-chain alkyl radical having 1-6 C atoms,
alkenyl and alkenyl* in each case, independently of one another, denote a straight-chain alkenyl radical having 2-6 C atoms, and
alkoxy denotes a straight-chain alkoxy radical having 1-6 C atoms.

9. The liquid-crystalline medium according to claim 1, further comprising one or more compounds of formulae O-1 to O-17
in which
R¹ and R² in each case, independently of one another, denote H, an alkyl or alkenyl radical having up to 15 C atoms, which is unsubstituted, monosubstituted by CN or CF₃ or at least monosubstituted by halogen, in which one or more CH₂ groups may be replaced by —O—, —S—,
—C≡C—, —CF₂O—, —OCF₂—, —OC—O— or —O—CO— in such a way that O atoms are not linked directly to one another.

10. The liquid-crystalline medium according to claim 1, in which the total concentration of the one or more compounds of formula EY is 2-15% by weight.

11. The liquid-crystalline medium according to claim 1, in which the total concentration of the compounds of formulae EY and IA and/or IB is 5-35% by weight.

12. The liquid-crystalline medium according to claim 1, further comprising at least one polymerisable compound, which is a reactive mesogen.

13. The liquid-crystalline medium according to claim 1, further comprising one or more additives selected from the group consisting of free-radical scavengers, antioxidants and UV stabilisers.

14. A process for the preparation of the liquid-crystalline medium according to claim 1, comprising mixing a compound of formula IA or IB with at least one compound of formula EY and with at least one further liquid-crystalline compound, and optionally one or more additives and optionally at least one polymerisable compound, which is a reactive mesogen.

15. An electro-optical display, comprising the liquid-crystalline medium according to claim 1.

16. An electro-optical display having active-matrix addressing, which contains, as dielectric, a liquid-crystalline medium according to claim 1.

17. The electro-optical display according to claim 16, which is a VA, PSA, PS-VA, PM-VA, SS-VA, PALC, IPS, PS-IPS, FFS or PS-FFS display.

18. The liquid-crystalline medium according to claim 1, which comprises one or more compounds selected from the group consisting of the compounds of formulae IA and IB and one or more compounds selected from the group consisting of the compounds of formulae BF-1, BF-2, BS-1 and BS-2.
